(19) United States
(12) Patent Application Publication
(10) Pub. No.: US 2023/0305580 A1
(43) Pub. Date: Sep. 28, 2023

(54) CONTROL DEVICE

(71) Applicant: HONDA MOTOR CO., LTD., Tokyo (JP)

(72) Inventors: Ryota Tsujimoto, Wako-shi (JP); Tomonori Shimada, Wako-shi (JP)

(21) Appl. No.: 18/186,543

(22) Filed: Mar. 20, 2023

(30) Foreign Application Priority Data
Mar. 22, 2022 (JP) 2022-044806

(51) Int. Cl. G05D 1/10

(52) U.S. Cl. CPC G05D 1/102; B64C 27/32

(57) ABSTRACT

A control device includes :a resultant thrust magnitude calculation unit that calculates a magnitude of a resultant thrust of a vertical thrust and a horizontal thrust, based on a magnitude of a thrust indicated by a signal output from a thrust adjustment lever; a resultant thrust angle setting unit that sets a resultant thrust angle in accordance with a speed of an aircraft; a component calculation unit that calculates a vertical component and a horizontal component of the resultant thrust; and a rotor control unit that controls a vertical rotor device to provide the vertical thrust having the vertical component and controls a horizontal rotor device to provide the horizontal thrust having the horizontal component.

### CROSS-REFERENCE TO RELATED APPLICATIONS

This application is based upon and claims the benefit of priority from Japanese Patent Application No. 2022-044806 filed on Mar. 22, 2022, the contents of which are incorporated herein by reference.

### BACKGROUND OF THE INVENTION

### Field of the Invention

The present invention relates to a control device for an aircraft including a vertical rotor device and a horizontal rotor device.

### Description of the Related Art

As an aircraft provided with a vertical rotor device and a horizontal rotor device, there is a vertical take-off and landing aircraft such as an eVTOL, an SVTOL, and a multicopter.

US 10160534 B2 discloses a lever for operating a multicopter. The lever is rotatable in a horizontal plane and has a range of motion. Depending on the position of the lever in the range of motion, the vertical thrust of the multicopter increases or decreases. The lever is provided with a thumb slider which is movable in the front-rear direction. Depending on the position of the thumb slider, the horizontal thrust of the multicopter increases or decreases.

### SUMMARY OF THE INVENTION

In an aircraft provided with a vertical rotor device and a horizontal rotor device, when transitioning from vertical take-off to cruise flight, it is required to increase horizontal thrust while decreasing vertical thrust. Conversely, when transitioning from cruise flight to vertical take-off, it is required to decrease the horizontal thrust while increasing the vertical thrust. In the case of the lever disclosed in US 10160534 B2, it is conceivable to operate the thumb slider with the thumb while operating the lever with one hand.

However, since the operation is performed by one hand and the finger of the one hand at the same time, it is complicated. In addition, it is necessary to perform the operation for the vertical thrust and the operation for the horizontal thrust at the same time. Therefore, it is required to simplify the operation of the aircraft.

An object of the present invention is to solve the above-mentioned problem.

According to an aspect of the present invention, there is provided a control device for an aircraft including a vertical rotor device configured to provide a vertical thrust, and a horizontal rotor device configured to provide a horizontal thrust, the control device comprising: a resultant thrust magnitude calculation unit configured to calculate a magnitude of a resultant thrust of the vertical thrust and the horizontal thrust based on a magnitude of a thrust, the magnitude of the thrust being indicated by a signal that is output from a thrust adjustment lever; a resultant thrust angle setting unit configured to set a resultant thrust angle that is an angle formed by the horizontal thrust and the resultant thrust, in accordance with a speed of the aircraft; a component calculation unit configured to calculate a vertical component and a horizontal component of the resultant thrust, based on the resultant thrust angle and the magnitude of the resultant thrust; and a rotor control unit configured to control the vertical rotor device to provide the vertical thrust having the vertical component, and control the horizontal rotor device to provide the horizontal thrust having the horizontal component.

According to the present invention, it is possible to adjust the balance between the vertical thrust and the horizontal thrust without forcing the operator (pilot) to perform the operation for the vertical thrust and the operation for the horizontal thrust at the same time. As a result, the operation of the aircraft can be simplified.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of an aircraft;

FIG. 2 is a schematic diagram geometrically showing forces acting on the aircraft by vectors;

FIG. 3 is a schematic diagram showing a configuration example of a cockpit; and

FIG. 4 is a block diagram showing a configuration of a control device.

### DETAILED DESCRIPTION OF THE INVENTION

### 1. Overall Configuration of Aircraft 10

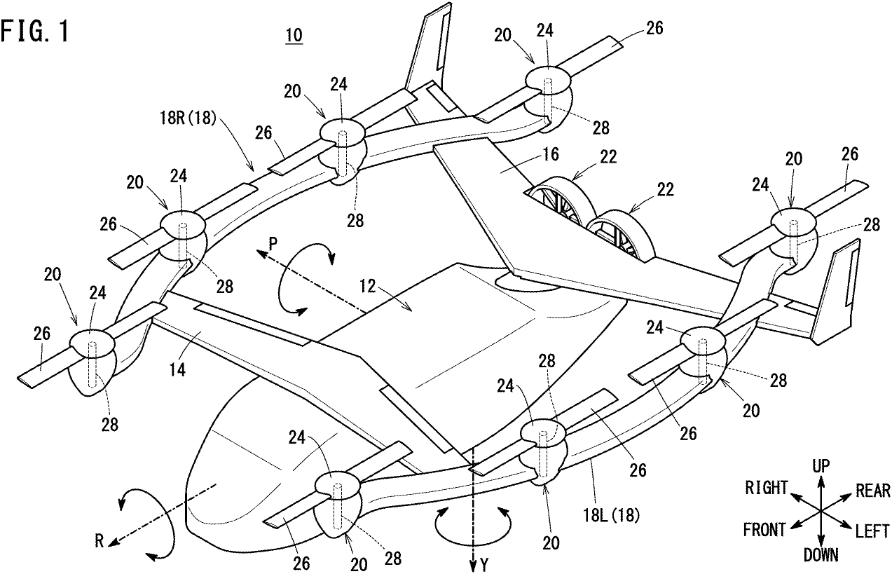

FIG. 1 is a perspective view of an aircraft 10. The aircraft 10 of the present embodiment is an eVTOL aircraft. However, the present invention is applicable to aircraft equipped with a vertical rotor device and a horizontal rotor device. Examples of such aircraft include, in addition to the eVTOL aircraft, SVTOL aircraft, multicopters, and the like. The multicopter includes a lift propulsor and a cruise propulsor whose thrust directions are fixed. Lift can also be obtained with a fixed wing.

The aircraft 10 includes a fuselage 12, a front wing 14, a rear wing 16, two booms 18, a plurality of vertical rotor devices 20, and a plurality of horizontal rotor devices 22. The fuselage 12 is long in the front-rear direction. The front wing 14 is disposed forward of an intermediate portion of the fuselage 12 in the front-rear direction. The front wing 14 is connected to an upper portion of the fuselage 12. The rear wing 16 is disposed rearward of the intermediate portion of the fuselage 12 in the front-rear direction. The rear wing 16 is connected to the fuselage 12.

The two booms 18 include a right boom 18R and a left boom 18L. Each boom 18 extends in the front-rear direction. The right boom 18R is disposed on the right side of the fuselage 12. The right boom 18R is curved rightward in an arc shape. The right boom 18R is connected to the right wing tip of the front wing 14 and connected to the right wing of the rear wing 16. The left boom 18L is disposed on the left side of the fuselage 12. The left boom 18L is curved leftward in an arc shape. The left boom 18L is connected to the left wing tip of the front wing 14 and connected to the left wing of the rear wing 16. Note that each boom 18 may have a straight shape.

Each boom 18 includes the plurality of vertical rotor devices 20. The vertical rotor devices 20 are devices for providing vertical thrust. In this embodiment, each boom 18 includes four vertical rotor devices 20. Note that the number of the vertical rotor devices 20 provided in each boom 18 may be two, three, or five or more. In each boom 18, the four vertical rotor devices 20 are sequentially arranged along the direction in which the boom 18 extends. Each vertical rotor device 20 includes a hub 24, a plurality of blades 26, and a propeller rotating shaft 28. The propeller rotating shaft 28 of at least one of the plurality of vertical rotor devices 20 may be angled (canted) a few degrees with respect to the up-down direction.

The fuselage 12 includes the plurality of horizontal rotor devices 22. The horizontal rotor devices 22 are devices for providing horizontal thrust. In the present embodiment, the fuselage 12 includes two horizontal rotor devices 22. Note that the number of the horizontal rotor devices 22 provided in the fuselage 12 may be one, or three or more. The two horizontal rotor devices 22 are arranged side by side in the left-right direction at the rear end portion of the fuselage 12. Each horizontal rotor device 22 includes a hub 24, a plurality of blades 26, and a propeller rotating shaft 28.

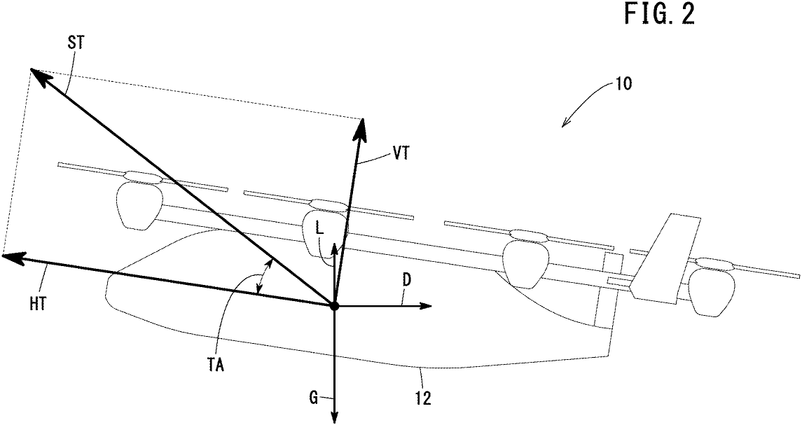

FIG. 2 is a schematic diagram geometrically showing forces acting on the aircraft 10 by vectors. When the aircraft 10 is cruising, gravity G, lift L, drag D, and thrust are acting on the aircraft 10. The thrust can be regarded as a resultant thrust (synthetic thrust) ST of vertical thrust VT and horizontal thrust HT. The vertical thrust VT is thrust in a direction perpendicular to the fuselage 12 and is provided by the vertical rotor devices 20. The horizontal thrust HT is thrust in a direction parallel to the fuselage 12 and is provided by the horizontal rotor devices 22. In the present embodiment, there is a mode in which the vertical rotor devices 20 and the horizontal rotor devices 22 are automatically controlled based on a resultant thrust angle TA which is an angle formed by the horizontal thrust HT and the resultant thrust ST.

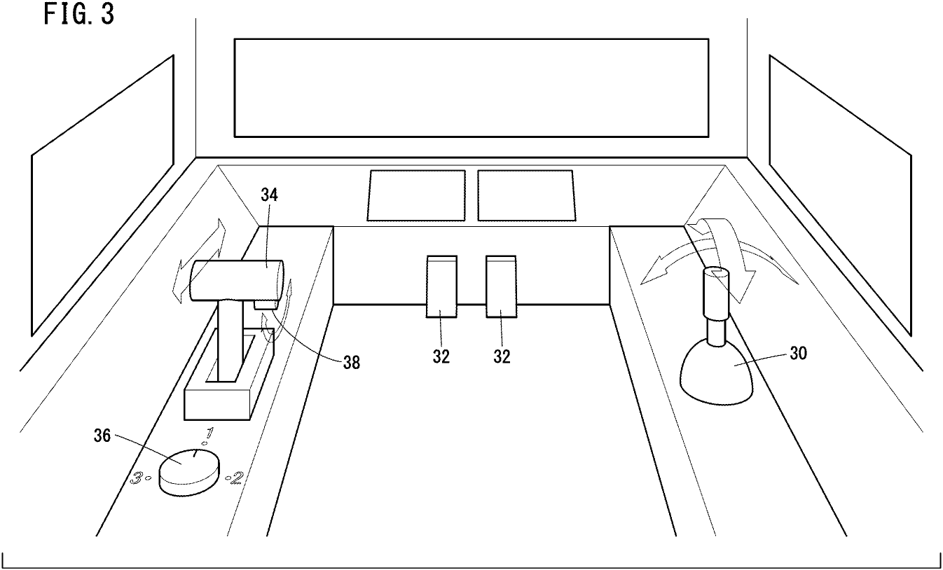

FIG. 3 is a schematic diagram showing a configuration example of a cockpit. The aircraft 10 further includes an attitude adjustment lever 30, pedals 32, a thrust adjustment lever 34, and a mode changeover switch 36.

The attitude adjustment lever 30 is an operation device for rotating the fuselage 12 about a roll axis R (FIG. 1) and a pitch axis P (FIG. 1). The attitude adjustment lever 30 is configured to be slidable in the front-rear and left-right directions from a reference position. When the attitude adjustment lever 30 slides forward from the reference position, the fuselage 12 rotates forward about the pitch axis P. When the attitude adjustment lever 30 slides rearward from the reference position, the fuselage 12 rotates rearward about the pitch axis P. When the attitude adjustment lever 30 slides to the right from the reference position, the fuselage 12 rotates clockwise about the roll axis R. When the attitude adjustment lever 30 slides to the left from the reference position, the fuselage 12 rotates counterclockwise about the roll axis R.

The two pedals 32 are operation devices for turning the fuselage 12 about a yaw axis Y (FIG. 1). The two pedals 32 are arranged side-by-side in the left-right direction. When the right pedal 32 is depressed, the fuselage 12 turns to the right about the yaw axis Y. When the left pedal 32 is depressed, the fuselage 12 turns to the left about the yaw axis Y. Note that the two pedals 32 are not essential components. When the attitude adjustment lever 30 is rotated clockwise, the fuselage 12 can turn to the right about the yaw axis Y. In addition, when the attitude adjustment lever 30 is rotated counterclockwise, the fuselage 12 can turn to the left about the yaw axis Y.

The thrust adjustment lever 34 is an operation device that outputs a signal indicating the magnitude of thrust. The thrust adjustment lever 34 is configured to be movable within a predetermined range of motion. FIG. 3 illustrates an example of the thrust adjustment lever 34 configured to be movable in a range of motion in the front-rear direction. When the thrust adjustment lever 34 is disposed at one end of the range of motion, the magnitude of the thrust indicated by a signal output from the thrust adjustment lever 34 is “0”. As the thrust adjustment lever 34 moves away from the one end of the range of motion, the magnitude of the thrust indicated by the signal output from the thrust adjustment lever 34 increases.

The thrust adjustment lever 34 is provided with an operation member 38 for adjusting the resultant thrust angle TA (FIG. 2). The operation member 38 outputs a signal indicating an adjustment amount of the resultant thrust angle TA (FIG. 2). The operation member 38 is configured to be operable by a finger of a hand gripping the thrust adjustment lever 34. The operation member 38 may be configured as a dial type or slide type operation member. The operation member 38 includes a first range of motion in which the operation member 38 is movable in a + direction from a reference position, and a second range of motion in which the operation member 38 is movable in a -direction from the reference position. When the operation member 38 is disposed at the reference position, the current resultant thrust angle TA is maintained. As the operation member 38 moves away from the reference position, the adjustment amount indicated by the signal output from the operation member 38 increases. When the operation member 38 is disposed in the first range of motion, the adjustment amount is added to the current resultant thrust angle TA. On the other hand, when the operation member 38 is disposed in the second range of motion, the adjustment amount is subtracted from the current resultant thrust angle TA.

The mode changeover switch 36 (FIG. 3) is a switch for selecting a mode for controlling the vertical rotor devices 20 and the horizontal rotor devices 22. The mode changeover switch 36 is configured to be able to select any one of a vertical thrust mode, a horizontal thrust mode, or a thrust adjustment mode. When the vertical thrust mode is selected, the resultant thrust angle TA (FIG. 2) is fixed at 90 degrees. When the horizontal thrust mode is selected, the resultant thrust angle TA is fixed at 0 degrees. When the thrust adjustment mode is selected, the resultant thrust angle TA is automatically adjusted in accordance with the speed of the aircraft 10.

### 2. Configuration of Control Device

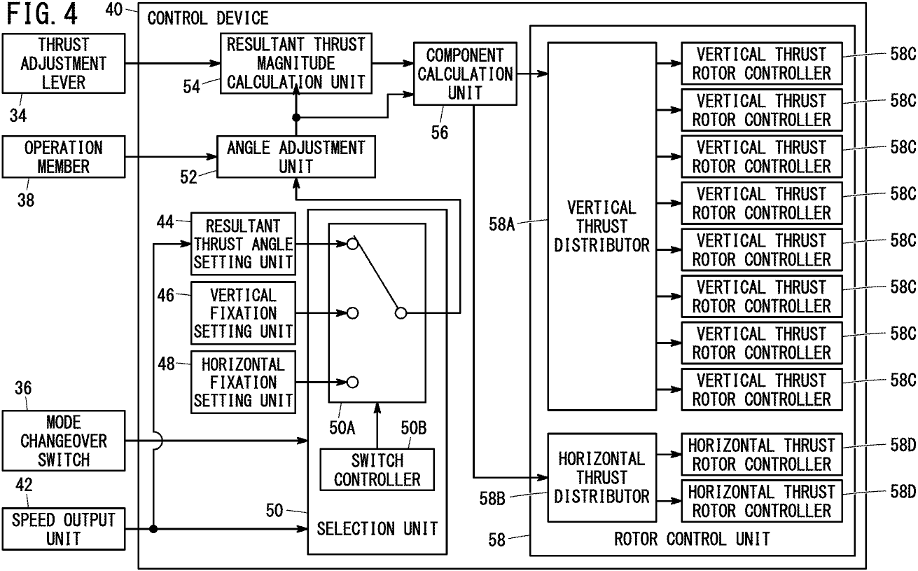

FIG. 4 is a block diagram showing a configuration of a control device 40. The control device 40 is connected to the thrust adjustment lever 34, the mode changeover switch 36, the operation member 38, and a speed output unit 42. The speed output unit 42 outputs a signal indicating the speed of the aircraft 10. The speed of the aircraft 10 may be an aircraft speed detected by a speed sensor, or an aircraft airspeed estimated by an air data system (ADS).

The control device 40 includes a resultant thrust angle setting unit 44, a vertical fixation setting unit 46, a horizontal fixation setting unit 48, a selection unit 50, an angle adjustment unit 52, a resultant thrust magnitude calculation unit 54, a component calculation unit 56, and a rotor control unit 58.

The resultant thrust angle setting unit 44 acquires the signal output from the speed output unit 42, and sets the resultant thrust angle TA corresponding to the speed of the aircraft 10 indicated by this signal. Upon setting the resultant thrust angle TA, the resultant thrust angle setting unit 44 generates an angle signal indicating this resultant thrust angle TA and outputs the angle signal to the selection unit 50.

The resultant thrust angle setting unit 44 sets the resultant thrust angle TA such that the resultant thrust angle TA decreases as the speed of the aircraft 10 increases. When the speed of the aircraft 10 is equal to or less than a predetermined speed, the resultant thrust angle setting unit 44 may fix the resultant thrust angle TA at a predetermined angle. In this case, when the speed of the aircraft 10 exceeds the predetermined speed, the resultant thrust angle setting unit 44 sets the resultant thrust angle TA to be smaller than the predetermined angle as the speed of the aircraft 10 increases.

The vertical fixation setting unit 46 generates a vertical signal indicating the resultant thrust angle TA of 90 degrees, and outputs the vertical signal to the selection unit 50. The horizontal fixation setting unit 48 generates a horizontal signal indicating the resultant thrust angle TA of 0 degrees, and outputs the horizontal signal to the selection unit 50.

The selection unit 50 selects any one of fixing the resultant thrust angle TA to 0 degree, fixing the resultant thrust angle TA to 90 degrees, or automatically adjusting the resultant thrust angle TA, in accordance with a switching operation performed by the pilot on the mode changeover switch 36 (FIG. 3). The selection unit 50 includes a switching unit 50A and a switch controller 50B.

The switching unit 50A connects any one of the resultant thrust angle setting unit 44, the vertical fixation setting unit 46, or the horizontal fixation setting unit 48 to the angle adjustment unit 52, based on the control of the switch controller 50B. When the resultant thrust angle setting unit 44 is connected to the angle adjustment unit 52, the angle signal is output to the angle adjustment unit 52. When the vertical fixation setting unit 46 is connected to the angle adjustment unit 52, the vertical signal is output to the angle adjustment unit 52. When the horizontal fixation setting unit 48 is connected to the angle adjustment unit 52, the horizontal signal is output to the angle adjustment unit 52.

The switch controller 50B controls the switching unit 50A based on the signal (the speed of the aircraft 10) output from the speed output unit 42 and the mode selected by the mode changeover switch 36. If the mode selected by the mode changeover switch 36 is the thrust adjustment mode, the switch controller 50B controls the switching unit 50A to connect the resultant thrust angle setting unit 44 to the angle adjustment unit 52 regardless of the speed of the aircraft 10.

If the mode selected by the mode changeover switch 36 is the vertical thrust mode, the switch controller 50B compares the speed of the aircraft 10 with a predetermined first speed threshold. When the speed of the aircraft 10 is less than the first speed threshold, the switch controller 50B controls the switching unit 50A to connect the vertical fixation setting unit 46 to the angle adjustment unit 52. Conversely, when the speed of the aircraft 10 is equal to or greater than the first speed threshold, the switch controller 50B restricts the selection of the vertical thrust mode. In this case, the switch controller 50B maintains the connection state of the resultant thrust angle setting unit 44 or the horizontal fixation setting unit 48 currently connected to the angle adjustment unit 52. This allows the current thrust direction to be maintained even if the vertical thrust mode is erroneously selected when the aircraft 10 is flying at a relatively high speed. It should be noted that, when the switch controller 50B restricts the selection of the vertical thrust mode, the control device 40 may control a display device or the like provided in the cockpit to alert the pilot that there is a possibility of an erroneous operation.

If the mode selected by the mode changeover switch 36 is the horizontal thrust mode, the switch controller 50B compares the speed of the aircraft 10 with a predetermined second speed threshold. The second speed threshold is a value smaller than the first speed threshold. When the speed of the aircraft 10 exceeds the second speed threshold, the switch controller 50B controls the switching unit 50A to connect the horizontal fixation setting unit 48 to the angle adjustment unit 52. Conversely, when the speed of the aircraft 10 is equal to or less than the second speed threshold, the switch controller 50B restricts the selection of the horizontal thrust mode. In this case, the switch controller 50B maintains the connection state of the resultant thrust angle setting unit 44 or the vertical fixation setting unit 46 currently connected to the angle adjustment unit 52. This allows the current thrust direction to be maintained even if the horizontal thrust mode is erroneously selected when the aircraft 10 is flying at a relatively low speed. It should be noted that, when the switch controller 50B restricts the selection of the horizontal thrust mode, the control device 40 may control the display device or the like provided in the cockpit to alert the pilot that there is a possibility of an erroneous operation.

The angle signal, the vertical signal, and the horizontal signal are supplied to the angle adjustment unit 52 from the selection unit 50. The angle adjustment unit 52 determines whether or not the mode selected by the mode changeover switch 36 is the thrust adjustment mode, based on the angle signal, the vertical signal, or the horizontal signal.

When the signal supplied from the selection unit 50 is the vertical signal or the horizontal signal, the angle adjustment unit 52 determines that the mode selected by the mode changeover switch 36 is not the thrust adjustment mode. In this case, the angle adjustment unit 52 outputs the vertical signal or the horizontal signal to the resultant thrust magnitude calculation unit 54. Further, the angle adjustment unit 52 outputs the vertical signal or the horizontal signal to the component calculation unit 56.

When the signal supplied from the selection unit 50 is the angle signal, the angle adjustment unit 52 determines that the mode selected by the mode changeover switch 36 is the thrust adjustment mode. In this case, the angle adjustment unit 52 increases or decreases the resultant thrust angle TA in accordance with the adjustment amount indicated by the signal from the operation member 38.

When the operation member 38 is disposed in the first range of motion, the angle adjustment unit 52 adds the adjustment amount indicated by the signal from the operation member 38, to the resultant thrust angle TA indicated by the angle signal. In this case, the angle adjustment unit 52 outputs an angle signal indicating the resultant thrust angle TA obtained after the addition of the adjustment amount, to the resultant thrust magnitude calculation unit 54 and the component calculation unit 56.

On the other hand, when the operation member 38 is disposed in the second range of motion, the angle adjustment unit 52 subtracts the adjustment amount indicated by the signal from the operation member 38, from the resultant thrust angle TA indicated by the angle signal. In this case, the angle adjustment unit 52 outputs an angle signal indicating the resultant thrust angle TA obtained after the subtraction of the adjustment amount, to the resultant thrust magnitude calculation unit 54 and the component calculation unit 56.

Further, when the operation member 38 is disposed at the reference position, the angle adjustment unit 52 outputs, as it is, the angle signal supplied from the selection unit 50, to the resultant thrust magnitude calculation unit 54 and the component calculation unit 56.

The angle adjustment unit 52 may subject the vertical angle indicated by the vertical signal to addition or subtraction in accordance with the adjustment amount indicated by the signal from the operation member 38. In this case, the angle adjustment unit 52 outputs a vertical signal indicating the vertical angle obtained after the addition or subtraction, to the resultant thrust magnitude calculation unit 54 and the component calculation unit 56. Similarly, the angle adjustment unit 52 may subject the horizontal angle indicated by the horizontal signal to addition or subtraction in accordance with the adjustment amount indicated by the signal from the operation member 38. In this case, the angle adjustment unit 52 outputs a horizontal signal indicating the horizontal angle obtained after the addition or subtraction, to the resultant thrust magnitude calculation unit 54 and the component calculation unit 56.

The resultant thrust magnitude calculation unit 54 calculates the magnitude of the resultant thrust ST based on the magnitude of the thrust indicated by the signal output from the thrust adjustment lever 34 (FIG. 3). The resultant thrust magnitude calculation unit 54 calculates the magnitude of the resultant thrust ST using an expression or a table indicating the relationship between the thrust and the resultant thrust ST.

For example, the resultant thrust magnitude calculation unit 54 calculates the magnitude of the resultant thrust ST by multiplying the magnitude of the thrust by a coefficient. The coefficient may be fixed or variable. When the coefficient is variable, the resultant thrust magnitude calculation unit 54 may acquire a signal output from the speed output unit 42 and change the coefficient in accordance with the speed of the aircraft 10 indicated by the signal. In this case, the coefficient decreases as the speed of the aircraft 10 increases. That is, the resultant thrust magnitude calculation unit 54 decreases the ratio of the magnitude of the resultant thrust ST to the magnitude of the thrust, as the speed of the aircraft 10 increases. As a result, the magnitude of the resultant thrust ST can be obtained in consideration of the lift L (FIG. 2) that increases as the speed of the aircraft 10 increases. It should be noted that the resultant thrust magnitude calculation unit 54 may calculate the magnitude of the resultant thrust corresponding to the magnitude of the thrust, without multiplying the magnitude of the thrust by the coefficient.

The component calculation unit 56 calculates the vertical component and the horizontal component of the resultant thrust ST based on the resultant thrust angle TA and the magnitude of the resultant thrust ST. The component calculation unit 56 also generates a vertical component command signal for specifying the calculated vertical component of the resultant thrust ST, and outputs the vertical component command signal to the rotor control unit 58. Similarly, the component calculation unit 56 generates a horizontal component command signal for specifying the calculated horizontal component of the resultant thrust ST, and outputs the horizontal component command signal to the rotor control unit 58.

When the signal supplied from the angle adjustment unit 52 is a vertical signal, the horizontal component of the resultant thrust ST is calculated as 0. However, when the vertical angle indicated by the vertical signal is increased or decreased in accordance with the adjustment amount, the vertical component and the horizontal component are calculated based on the increased or decreased angle and the magnitude of the resultant thrust ST. Similarly, when the signal supplied from the angle adjustment unit 52 is a horizontal signal, the vertical component of the resultant thrust ST is calculated as 0. However, when the horizontal angle indicated by the horizontal signal is increased or decreased in accordance with the adjustment amount, the vertical component and the horizontal component are calculated based on the increased or decreased angle and the magnitude of the resultant thrust ST.

The rotor control unit 58 controls the vertical rotor device 20 to provide the vertical thrust VT having the vertical component, and controls the horizontal rotor device 22 to provide the horizontal thrust HT having the horizontal component. The rotor control unit 58 includes a vertical thrust distributor 58A, a horizontal thrust distributor 58B, a plurality of vertical thrust rotor controllers 58C, and a plurality of horizontal thrust rotor controllers 58D.

The vertical thrust distributor 58A outputs the vertical component command signal supplied from the component calculation unit 56 to each of the plurality of vertical thrust rotor controllers 58C. The horizontal thrust distributor 58B outputs the horizontal component command signal supplied from the component calculation unit 56 to each of the plurality of horizontal thrust rotor controllers 58D.

The plurality of vertical thrust rotor controllers 58C are connected to the plurality of vertical rotor devices 20 on a one to-one basis. The vertical thrust rotor controllers 58C each control at least one of the rotational speed of the motor that drives the propeller rotating shaft 28 (FIG. 1) or the angle (pitch angle) of the blades 26 (FIG. 1), based on the vertical component command signal. As a result, the vertical thrust VT is provided in the vertical rotor device 20.

When the angle adjustment unit 52 subjects the horizontal angle indicated by the horizontal signal to subtraction in accordance with the adjustment amount indicated by the signal from the operation member 38, the vertical thrust rotor controllers 58C each reverse the pitch angle of the blades 26, for example.

The plurality of horizontal thrust rotor controllers 58D are connected to the plurality of horizontal rotor devices 22 on a one to-one basis. The horizontal thrust rotor controllers 58D each control at least one of the rotational speed of the motor that drives the propeller rotating shaft 28 (FIG. 1) or the angle (pitch angle) of the blades 26 (FIG. 1), based on the horizontal component command signal. As a result, the horizontal thrust HT is provided in the horizontal rotor device 22.

When the angle adjustment unit 52 subjects the vertical angle indicated by the vertical signal to addition in accordance with the adjustment amount indicated by the signal from the operation member 38, the horizontal thrust rotor controllers 58D each reverse the pitch angle of the blades 26, for example.

### 3. Thrust Adjustment Mode

Next, a flow of a process of a thrust adjustment mode will be described. Here, a case in which the thrust adjustment mode is selected at the time of take-off will be described as an example. When the thrust adjustment mode is selected, the resultant thrust angle setting unit 44 sets the resultant thrust angle TA to, for example, 90 degrees until the speed of the aircraft 10 output from the speed output unit 42 exceeds a predetermined speed.

In this case, the component calculation unit 56 generates a vertical component command signal indicating the vertical component of the resultant thrust ST, and the rotor control unit 58 controls each vertical rotor device 20 based on the vertical component command signal. On the other hand, the component calculation unit 56 generates a horizontal component command signal indicating the horizontal component of the resultant thrust ST, and the rotor control unit 58 controls each horizontal rotor device 22 based on the horizontal component command signal. Thus, only the vertical thrust VT is applied to the aircraft 10 as a result of setting the resultant thrust angle TA to 90 degrees.

Thereafter, when the speed of the aircraft 10 indicated by the signal from the speed output unit 42 exceeds the predetermined speed, the resultant thrust angle setting unit 44 decreases the resultant thrust angle TA as the speed of the aircraft 10 increases.

In this case, the vertical thrust VT provided by each vertical rotor device 20 gradually decreases as compared with a case where the resultant thrust angle TA is 90 degrees. On the other hand, the horizontal thrust HT provided by each horizontal rotor device 22 gradually increases as compared with the case where the resultant thrust angle TA is 90 degrees. As a result, the thrust acting on the aircraft 10 gradually transitions from the vertical thrust VT to the horizontal thrust HT.

In this manner, the control device 40 automatically controls the vertical rotor devices 20 and the horizontal rotor devices 22. Thus, the balance between the vertical thrust VT and the horizontal thrust HT can be adjusted without performing the operation for adjusting the vertical rotor devices 20 and the operation for adjusting the horizontal rotor devices 22 at the same time. As a result, the operation of the aircraft 10 can be simplified.

### 4. Invention Obtained From Embodiment

The invention and effects that can be grasped from the above-described embodiment will be described below.

(1) According to an aspect of the present invention, provided is the control device (40) for the aircraft (10) including the vertical rotor device (20) configured to provide the vertical thrust (VT), and the horizontal rotor device (22) configured to provide the horizontal thrust (HT), the control device including: the resultant thrust magnitude calculation unit (54) configured to calculate the magnitude of the resultant thrust (ST) of the vertical thrust and the horizontal thrust, based on the magnitude of the thrust, the magnitude of the thrust being indicated by the signal that is output from the thrust adjustment lever (34); the resultant thrust angle setting unit (44) configured to set the resultant thrust angle (TA) that is an angle formed by the horizontal thrust and the resultant thrust, in accordance with the speed of the aircraft; the component calculation unit (56) configured to calculate the vertical component and the horizontal component of the resultant thrust, based on the resultant thrust angle and the magnitude of the resultant thrust; and the rotor control unit (58) configured to control the vertical rotor device to provide the vertical thrust having the vertical component, and control the horizontal rotor device to provide the horizontal thrust having the horizontal component.

According to this feature, it is possible to adjust the balance between the vertical thrust and the horizontal thrust without forcing the pilot to perform the operation for the vertical thrust and the operation for the horizontal thrust at the same time. As a result, the operation of the aircraft can be simplified.

(2) In the above-described control device for the aircraft, the resultant thrust angle setting unit may decrease the resultant thrust angle as the speed of the aircraft increases. According to this feature, it is possible to smoothly transition the thrust according to the speed of the aircraft, and as a result, it is possible to simplify the operation of the aircraft at the time of take-off, landing, and the like.

(3) In the above-described control device for the aircraft, after the speed of the aircraft exceeds the predetermined speed, the resultant thrust angle setting unit may decrease the resultant thrust angle as the speed of the aircraft increases.

(4) In the above-described control device for the aircraft, the resultant thrust magnitude calculation unit may decrease the magnitude of the resultant thrust with respect to the magnitude of the thrust as the speed of the aircraft increases. According to this feature, the magnitude of the resultant thrust can be obtained in consideration of the lift that increases as the speed of the aircraft increases.

(5) In the above-described control device for the aircraft, the aircraft may further include the operation member (38) configured to adjust the resultant thrust angle set by the resultant thrust angle setting unit, and the control device may further include the angle adjustment unit (52) configured to increase or decrease the resultant thrust angle in accordance with the adjustment amount of the resultant thrust angle, the adjustment amount being indicated by the signal that is output from the operation member. According to this feature, the resultant thrust angle can be finely adjusted.

(6) In the above-described control device for the aircraft, the operation member may be provided on the thrust adjustment lever. According to this feature, the operation member can be operated by, for example, a finger of a hand gripping the thrust adjustment lever.

(7) The above-described control device for the aircraft may further include the selection unit (50) configured to perform selection to select, in accordance with the switching operation by the pilot, any one of the horizontal signal indicating the resultant thrust angle of 0 degrees, the vertical signal indicating the resultant thrust angle of 90 degrees, or the angle signal indicating the resultant thrust angle that is set by the resultant thrust angle setting unit. According to this feature, the adjustment of the resultant thrust angle can be switched to automatic adjustment in accordance with the intention of the pilot.

(8) In the above-described control device for the aircraft, the selection unit may restrict the selection in accordance with the speed of the aircraft. According to this feature, even if the vertical thrust mode or the horizontal thrust mode is erroneously selected, the safety of the aircraft can be maintained.

The present invention is not limited to the above disclosure, and various modifications are possible without departing from the essence and gist of the present invention.

1. A control device for an aircraft including a vertical rotor device configured to provide a vertical thrust, and a horizontal rotor device configured to provide a horizontal thrust,
wherein the control device is configured to:
calculate a magnitude of a resultant thrust of the vertical thrust and the horizontal thrust based on a magnitude of a thrust, the magnitude of the thrust being indicated by a signal that is output from a thrust adjustment lever;
set a resultant thrust angle that is an angle formed by the horizontal thrust and the resultant thrust, in accordance with a speed of the aircraft;
calculate a vertical component and a horizontal component of the resultant thrust, based on the resultant thrust angle and the magnitude of the resultant thrust; and
control the vertical rotor device to provide the vertical thrust having the vertical component, and control the horizontal rotor device to provide the horizontal thrust having the horizontal component.

2. The control device according to claim 1, wherein
the control device decreases the resultant thrust angle as the speed of the aircraft increases.

3. The control device according to claim 1, wherein
after the speed of the aircraft exceeds a predetermined speed, the control device decreases the resultant thrust angle as the speed of the aircraft increases.

4. The control device according to claim 1, wherein the control device decreases the magnitude of the resultant thrust with respect to the magnitude of the thrust as the speed of the aircraft increases.

5. The control device according to claim 1, wherein
an operation member configured to adjust the resultant thrust angle that has been set is connected to the control device, and
the control device increases or decreases the resultant thrust angle in accordance with an adjustment amount of the resultant thrust angle, the adjustment amount being indicated by a signal that is output from the operation member.

6. The control device according to claim 5, wherein
the operation member is provided on the thrust adjustment lever.

7. The control device according to claim 1, wherein
in accordance with a switching operation by a pilot, the control device performs selection to select any one of a horizontal signal indicating the resultant thrust angle of 0 degrees, a vertical signal indicating the resultant thrust angle of 90 degrees, or an angle signal indicating the resultant thrust angle that is set by the control device.

8. The control device according to claim 7, wherein
the control device restricts the selection in accordance with the speed of the aircraft.
